(19) United States
(12) Patent Application Publication
(10) Pub. No.: US 2017/0255258 A1
(43) Pub. Date: Sep. 7, 2017

(54) Imperceptible Automatic Field-of-View Restrictors to Combat VR Sickness and Cybersickness

(71) Applicant: The Trustees Of Columbia University In the City of New York, New York, NY (US)

(72) Inventors: Steven K. Feiner, New York, NY (US); Ajoy Savio Fernandes, New York, NY (US)

(73) Assignee: The Trustees Of Columbia University In the City of New York, New York, NY (US)

(21) Appl. No.: 15/447,986

(22) Filed: Mar. 2, 2017

Related U.S. Application Data
(60) Provisional application No. 62/302,632, filed on Mar. 2, 2016.

(51) Int. Cl. G06F 3/01

(52) U.S. Cl. CPC G06F 3/013; G06T 19/006

(57) ABSTRACT

The present disclosure provides an eye-tracked field of view restrictor for a virtual reality, augmented reality, and/or mixed reality system that reduces the effects of virtual reality sickness and/or cybersickness. A field of view restrictor with a soft-edge, hard edge, or arbitrary dynamic aperture is utilized, and the aperture is adjusted to increase and/or decrease the perceived field of view in the augmented reality, virtual reality, and/or mixed reality system. Each field of view restrictor moves in response to the movement of an operator's eyes as tracked by an eye tracking system, such that the eye-tracker can direct the positioning, repositioning, and/or reorientation of the field of view restrictors. The adjustments can be imperceptible to the operator.

### CROSS REFERENCE TO RELATED APPLICATION

This application is related to, and claims priority from, Provisional Patent Application No. 62/302,632, entitled “Imperceptible Automatic Field-of-View Restrictors to Combat VR Sickness and Cybersickness,” which was filed on Mar. 2, 2016, the entire contents of which are incorporated by reference herein.

### STATEMENT REGARDING FEDERALLY SPONSORED RESEARCH

This invention was made with government support under Grants Nos. IIS-0905569 and U.S. Pat. No. 1,514,429, awarded by the National Science Foundation. The government has certain rights in the invention.

### BACKGROUND

Embodiments of the present disclosure generally relate to virtual reality, augmented reality, and/or mixed reality, including techniques for reducing virtual reality sickness.

Virtual reality (VR) head-worn displays (HWDs) are becoming commonly available products. However, a barrier to adoption of VR can be VR sickness, which can cause symptoms similar to those of motion sickness. These symptoms include headaches, stomach awareness, nausea, vomiting, pallor, sweating, fatigue, drowsiness, and disorientation. In certain work on vehicle simulators using a variety of display technologies, researchers noted that people develop a tolerance to the related experience of simulator sickness over multiple sessions, and that by having users undergo an adaptation program, such as through increasing exposure time by session, users can more easily adapt to the experience. However, given the unpleasantness of some of the symptoms, having a bad first experience can deter users from trying a system again.

According to sensory conflict theory, moving virtually in a different way than moving physically, creates a mismatch between information on motion from the visual system and the vestibular system, and it is this mismatch that induces VR sickness. High-precision low-latency tracking, high-frame-rate rendering, and short-persistence displays have sometimes been claimed to eliminate or reduce VR sickness, insofar as they can minimize the mismatch between a user's visual perception of the virtual environment (VE) and the response of her vestibular system. While this can help users who are in motion, it does not necessarily address users who do not or cannot move physically the same way they move virtually. This can be the case when the user's tracked environment is significantly smaller than the VE she wishes to explore, when the user prefers to remain relatively stationary physically when moving virtually, or when the user is simply unable to move physically because of a disability. In scenarios in which actual physical and intended virtual motion are significantly and inescapably mismatched, VR sickness cannot necessarily be eliminated by tracking and responding to physical motion with greater accuracy.

VR sickness can therefore slow the rate at which VR displays are adopted and decrease the amount of time that VR systems are used. What is needed is a system that can help reduce VR sickness while having reduced impact on the user's sense of presence or immersion in the virtual environment.

### SUMMARY

The present disclosure provides an eye-tracked and a non-eye-tracked field of view restrictor for a virtual reality system which reduces the effects of virtual reality sickness and/or cybersickness. A field of view restrictor with a soft-edge, hard edge, or arbitrary dynamic aperture can be utilized, and the aperture is adjusted to increase and/or decrease the perceived field of view in the augmented reality, virtual reality, and/or mixed reality system. The aperture can be modified in shape (e.g., anisotropically) and/or moved in response to the movement of an operator's eyes as tracked by an eye tracking system, such that the eye-tracker can direct the positioning, repositioning, and/or reorientation of the field of view restrictors. The aperture can scale as a function of optical flow, player movement, player kinematics, and/or biometric signals, among other factors. The center of the aperture can move to follow the gaze ray (the ray in the direction in which the eye of an operator of the system is looking). As such, the operator's eye can be tracked such that the field of view restrictor follows the eye, making it possible to reduce the field of view without the reduction being perceptually detected by the operator. The adjustments can be imperceptible or perceptible to the operator.

In certain example embodiments, a virtual reality system for rendering a restricted field of view on a display is disclosed. The virtual reality system includes a virtual reality headset, at least one display operatively connected to the virtual reality headset, and at least one eye tracker configured to track the gaze of an eye of an operator. The at least one eye tracker is operatively connected to the virtual reality headset. The virtual reality system also includes an eye-tracked field of view restricting system and a controller. The eye-tracked field of view restricting system includes at least one field of view restrictor having a static or dynamic aperture of variable transparency. The at least one field of view restrictor is configured to move as a function of the gaze of the eye of the operator. The controller is operatively connected to the virtual reality headset, the display, the at least one eye tracker, and the eye-tracked field of view restricting system. Furthermore, the controller is adapted to adjust the field of view restrictor in real time in response to the eye tracker.

In other example embodiments, a virtual reality system for rendering a restricted field of view on a display is disclosed. The virtual reality system includes a virtual reality headset, at least one display operatively connected to the virtual reality headset, a field of view restricting system, and a controller. The field of view restricting system includes at least one field of view restrictor having a static or dynamic aperture disposed in proximity to a center of the field of view restrictor. The aperture has an inner radius and an outer radius defining an opening, wherein the opening is adapted to increase in opacity from transparent within the inner radius to opaque beyond the outer radius. The controller is operatively connected to the virtual reality headset, the display, and the field of view restricting system. Furthermore, the controller is adapted to adjust the field of view restrictor in real time.

In further example embodiments, a virtual reality system for reducing virtual reality sickness includes a device, at least one display operatively connected to the device, and an eye tracker configured to track a gaze of an operator. The eye tracker is coupled to the device. The virtual reality system also includes an eye-tracked field of view restricting system and a controller. The eye-tracked field of view restricting system includes at least one field of view restrictor having a dynamic aperture. The at least one field of view restrictor is configured to move as a function of the gaze of the operator. The controller is operatively connected to the device, the display, the at least one eye tracker, and the eye tracked field of view restricting system. Furthermore, the controller is adapted to adjust the field of view restrictor in real time in response to the eye tracker.

### BRIEF DESCRIPTION OF THE DRAWINGS

So that the manner in which the above recited features of the present disclosure can be understood in detail, a more particular description of the disclosure, briefly summarized above, can be had by reference to embodiments, some of which are illustrated in the appended drawings. It is to be noted, however, that the appended drawings illustrate only exemplary embodiments and are therefore not to be considered limiting of its scope, and can admit to other equally effective embodiments.

FIG. 1A schematically illustrates a virtual reality system, according to an example embodiment.

FIG. 1B schematically illustrates a field of view restrictor with eye tracking for a virtual reality system, according to an example embodiment.

FIG. 1C schematically illustrates a dynamic aperture or cutout in a field of view restrictor for a virtual reality system, according to an example embodiment.

FIGS. 2A-2C each schematically illustrate various field of view restrictors, according to example embodiments.

FIGS. 3A-3F each illustrate a soft edged cutout having various transparencies, according to at least one example embodiment described herein.

FIG. 4A schematically illustrates a third-person view without a field of view restrictor.

FIG. 4B schematically illustrates the view of FIG. 4A as seen by the operator on a display.

FIG. 4C schematically illustrates a third-person view, according to an example embodiment.

FIG. 4D schematically illustrates the view of FIG. 4C as seen by the operator on a display, according to an example embodiment.

FIG. 4E schematically illustrates a third-person view, according to an example embodiment.

FIG. 4F schematically illustrates the view of FIG. 4E as seen by the operator on a display, according to an example embodiment.

FIG. 4G schematically illustrates a view with a soft-edged field-of-view restrictor, as seen by the operator on a display, according to an example embodiment.

FIG. 4H schematically illustrates an alternate effect on the display as in FIG. 4F, according to an example embodiment.

FIGS. 5A and 5B schematically illustrate an example of a hard edged scalable field of view restrictor, according to an example embodiment.

FIG. 5C schematically illustrates an example of a soft edged scalable field of view restrictor, according to an example embodiment.

FIGS. 6 and 7 each schematically illustrate an example field of view restrictor eye tracking system, according to an example embodiment.

To facilitate understanding, identical reference numerals have been used to designate identical elements that are common to the figures. It is contemplated that elements and features of one embodiment can be beneficially incorporated in other embodiments without further recitation.

### DETAILED DESCRIPTION

The disclosed subject matter provides an eye-tracked field of view restrictor for a virtual reality system which reduces the effects of virtual reality sickness and/or cybersickness. A field of view restrictor with a soft-edge, hard edge, or arbitrary dynamic aperture can be utilized, and the aperture is adjusted to increase and/or decrease the perceived field of view in the augmented reality, virtual reality, and/or mixed reality system. The aperture can be modified in shape (e.g., anisotropically) and/or moved in response to the movement of an operator's eyes as tracked by an eye tracking system, such that the eye-tracker can direct the positioning, repositioning, and/or reorientation of the field of view restrictors. The aperture can scale as a function of optical flow, player movement, player kinematics, and/or biometric signals, among other factors. The center of the aperture can move to follow the gaze ray (the ray in the direction in which the eye of an operator of the system is looking). As such, the operator's eye can be tracked such that the field of view restrictor follows the eye, making it possible to reduce the field of view without the reduction being perceptually detected by the operator. The adjustments can be imperceptible or perceptible to the operator.

Additionally and described herein, a non-eye-tracked restrictor can reduce the FOV in a way that is imperceptible to the operator. However, an eye-tracked restrictor can reduce the field of view even further, while still being imperceptble to the operator, as also described herein.

The term “user” or “operator” as used herein includes, for example, a person who views a virtual environment via a virtual reality system, device, computing device, or a wireless device, any of which can include a virtual reality system; a person or entity that owns a virtual reality device, computing device, or wireless device, any of which can include a virtual reality system; a person or entity that operates or utilizes a virtual reality device, computing device, or a wireless device, any of which can include a virtual reality system; or a person or entity that is otherwise associated with a virtual reality device, computing device, or a wireless device, any of which can include a virtual reality system. It is contemplated that the terms “user” and “operator” are not intended to be limiting and can include various examples beyond those described.

There is a relationship between display Field of View (FOV) and VR/simulator sickness. Decreasing FOV, in general, can decrease sickness. However, there is also a relationship between FOV and presence, which is the subjective experience of being in one environment, even when one is physically situated in another. Decreasing FOV can reduce the user's sense of presence.

To reconcile these two effects, FOV can be dynamically decreased in situations in which a larger FOV would be likely to cause VR sickness; for example, when the mismatch between physical and virtual motion increases. Further, FOV can be dynamically restored in situations in which VR sickness would be less likely to occur; for example, when the mismatch decreases. It can also be advantageous to change the FOV in a sufficiently subtle way such that an operator does not perceive that a change is occurring (or such that the change is not noticeable and/or distracting), although the operator can benefit from the change (as manifested by a reduction in VR sickness) while not experiencing a noticeably decreased sense of presence.

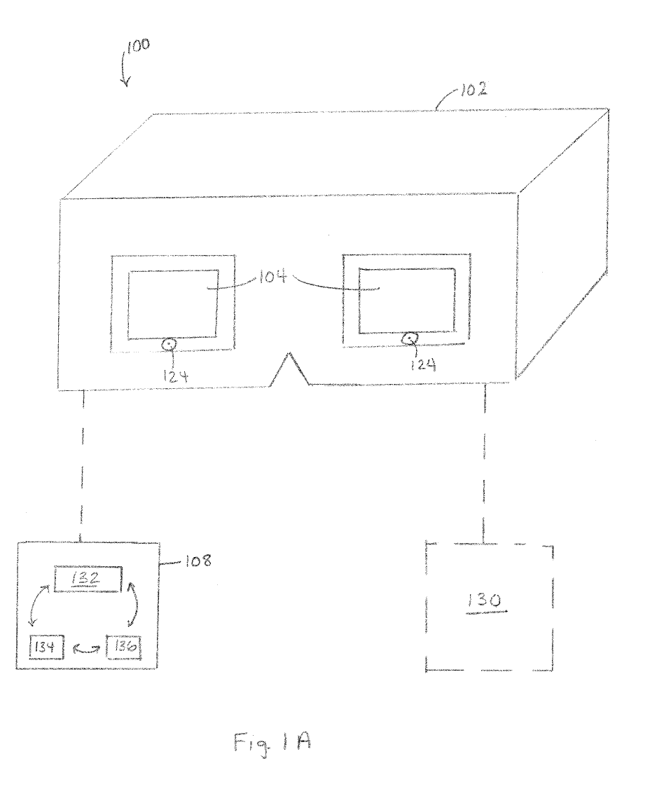

FIG. 1 schematically illustrates an example virtual reality system 100. The virtual reality system 100 includes a device 102, at least one display 104, a field of view restricting system 106, and a controller 108. The device 102 can be a virtual reality device, and in some embodiments, the device 102 can include televisions, monitors, tablets, and wall projection displays, among other suitable devices for virtual reality, game play, and/or content viewing.

As shown in FIG. 1A, the virtual reality device 102 can be a virtual reality headset, or any other suitable virtual reality, mixed reality, and/or augmented reality device. As shown, the display 104 is operatively connected to the virtual reality headset such that when an operator places the virtual reality headset over their eyes, the operator can view the display 104. In certain embodiments, there can be one display 104 for each eye.

With reference to FIGS. 1A-1C, the virtual reality system 100 further includes a field of view restricting system 106. The field of view restricting system 106 includes at least one field of view restrictor 112 having a dynamic aperture 114 disposed in proximity to a center 116 of the field of view restrictor 112. The dynamic aperture 114 has an inner radius 118 and an outer radius 120 defining an opening 122. The opening 122 is adapted to increase in opacity from transparent within the inner radius 118 to opaque beyond the outer radius 120. The area within the inner radius 118 is also a part of the opening 122. In a non-eye-tracked field of view restricting system embodiment, each field of view restrictor 112, or any component thereof, can dynamically and imperceptibly or subtly change in scale, transparency, color, and/or deform in shape dynamically. In other embodiments, each field of view restrictor 112, or any component thereof, can dynamically and noticeably change in scale, transparency, color, and/or deform in shape dynamically. In yet other embodiments, each field of view restrictor 112, or any component thereof, can maintain a set of visual characteristics that do not change, where the field of view of the scene occluded by the field of view restrictors 112 can either be noticable, imperceptible, or subtle.

The field of view restrictor 112 can be a non-physical medium or a physical medium. Further, the field of view restrictor 112 can be implemented, in some embodiments, via the use of a shader or a texture. In certain embodiments, the field of view restrictor 112 can be implemented via the use of procedural graphics (e.g., to define the restrictor geometry as a mesh) instead of a texture, or via virtual rendering. As such, the field of view restrictor 112 can constructed from physical hardware or implemented as software or firmware.

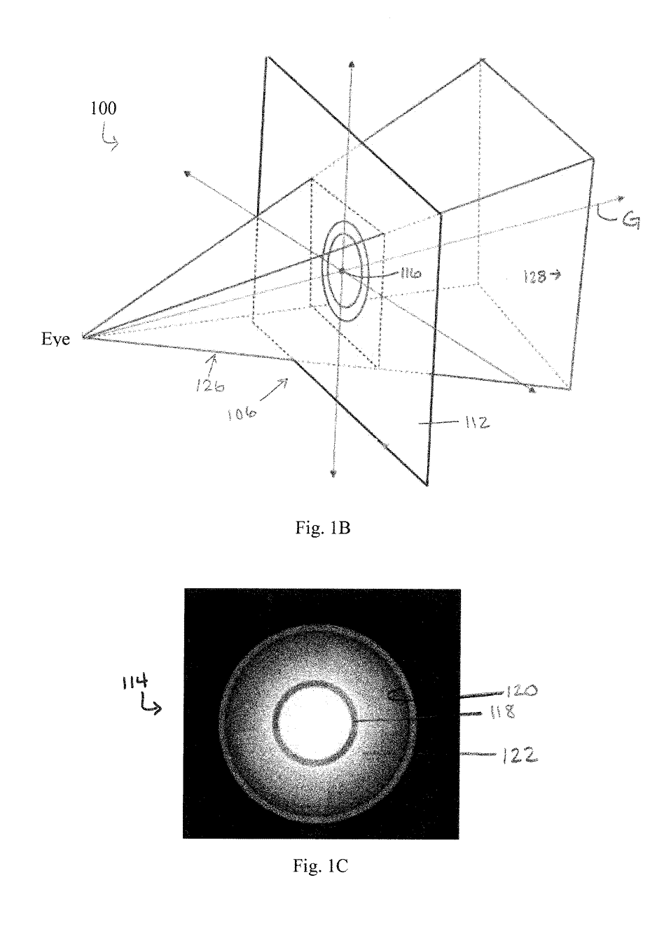

To manipulate the field of view perceived by an operator of the virtual reality system 100, the field of view restrictor 112 is disposed in front of the approximate center of projection of the view frustum 126, and parallel to its base 128. The field of view restrictor 104 can have any suitable shape, for example, an ellipse or the shape defined by the portions of the operator's face that bound an eye's field of view. In some embodiments, the field of view restrictor 112 is a variable transparency polygon. In one embodiment, the field of view restrictor 112 is a black polygon pierced by a soft-edged hole, which can dynamically change in size (FIG. 2B). The virtual environment can contain a pair of field of view restrictors 112, one in front of each of the operator's eyes, through which the operator views the virtual environment.

Each field of view restrictor 112 can be rendered with a dynamic aperture 114 in the center, which forms a see-through cutout. Each field of view restrictor 104 can be placed at the same fixed distance from its center of projection, and when scaled up or down, respectively, about its center, increases or decreases the perceived field of view.

In one embodiment, the field of view restrictor 112 can be scaled no smaller than the planar cross section of the virtual frustum 126 in which the field of view restrictor 112 resides, to prevent the scene from being viewed around the field of view restrictor 112.

As discussed, the field of view restrictor 112 includes a dynamic aperture 114 disposed therein. In some embodiments, the dynamic aperture 114 is a soft-edged cutout. In some embodiments, the dynamic aperture 112 can change dynamically in size and/or transparency. The dynamic aperture 114 can be disposed in proximity (e.g., immediately next to or adjacent) to a center of the field of view restrictor 112. In some embodiments, the dynamic aperture 114 is utilized and placed in front of the operator's eye.

The aperture 114 is dynamic in that it can be scaled up and or scaled down to increase and/or decrease the perceived field of view in an augmented reality, virtual reality, and/or mixed reality system. The dynamic aperture 114 is disposed in an approximate center of the field of view restrictor 112; however, it is contemplated that the dynamic aperture 114 can be disposed at any suitable location of the field of view restrictor 112. Furthermore, in some embodiments, a size of the dynamic aperture 114 is adjustable in response to discrepancies between the physical motion of the user's head and virtual motion of the user's view of the virtual world.

In some embodiments, the dynamic aperture 114 has variable transparency, creating a vignetting effect. In some implementations, the variable transparency can range from 100% transparent to 0% transparent. The dynamic aperture 114 can be of any suitable shape, for example, circular, ovular, square, rectangular, or the like. The size of the dynamic aperture 114 is adjustable in response to discrepancies between the physical motion of the user's head and the virtual motion of the user's avatar's head.

It is contemplated, however, that in some embodiments the aperture 114 can be a static aperture. The static aperture can be eye-tracked or non-eye-tracked, as discussed infra.

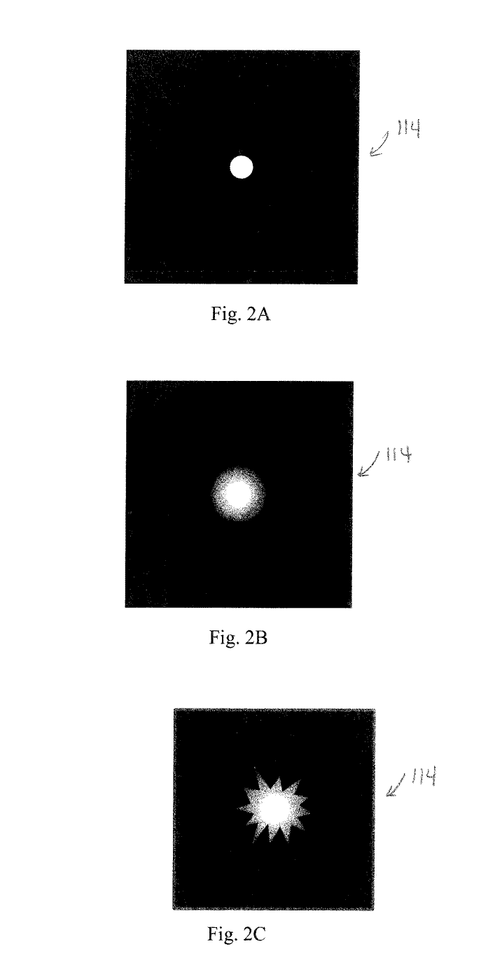

As shown in FIG. 1C, the dynamic aperture 114 can be defined by an inner radius 118 and an outer radius 120. The inner radius 118 and the outer radius 120 specify an opening 122 that increases in opacity from transparent within the inner radius, corresponding to an inner field of view (IFOV) to opaque beyond the outer radius, corresponding to an outer field of view (OFOV). In certain embodiments, the inner radius 118 and the outer radius 120 specify an opening 122 that linearly increases in opacity from completely transparent within the inner radius to completely opaque beyond the outer radius. The area within the inner radius 118 can be a part of the opening 122. To implement a hard edge cutout, IFOV can be set equal to OFOV. To create a soft edged cutout and/or a vignetting effect, IFOV can be set to less than OFOV, causing transparency to decrease linearly from IFOV to OFOV, as shown in FIGS. 3A-3F. Alternatively, the change in transparency can follow some other function (e.g., logarithmic). In one embodiment, the entire restrictor could be scaled up or down; in other embodiments, the IFOV and/or the OFOV could independently be scaled up or down.

In some embodiments, the at least one field of view restrictor 112 is configured to move as a function of the gaze of the eye of the operator. As such, the field of view restricting system 106 can be an eye tracked field of view restricting system by including an eye tracker 124 in the virtual reality system 100 and/or within the virtual reality device 102. The eye tracker 124 is configured to track a gaze of an operator. It is contemplated that any suitable eye tracking technology can be utilized, including, but not limited to, a physical camera or one or more other sensors, among other suitable devices. The at least one field of view restrictor 112 is configured to move as a function of the gaze of the operator, when operatively connected with an eye tracker 124. An eye-tracked field of view restricting system is one in which each field of view restrictor 112 moves as a function of the operator's gaze. In certain embodiments, each field of view restrictor 112, or any component thereof, can dynamically and imperceptibly or subtly change in scale, transparency, color, and/or deform in shape dynamically. In other embodiments, each field of view restrictor 112, or any component thereof, can dynamically and noticeably change in scale, transparency, color, and/or deform in shape dynamically. In other embodiments, each field of view restrictor 112, or any component thereof, can also maintain a set of visual characteristics that do not change, where the field of view of the scene occluded by the field of view restrictors 112 can either be noticable, imperceptible, or subtle.

Each eye tracker 124 tracks at least one eye of the user to collect data about the movement of the specific eye. Each eye tracker 124 outputs gaze rays in the virtual environment, which in turn repositions at least one field of view restrictor 112. The dynamic aperture 114 and/or field of view restrictor 112 can scale as a function of optical flow, player movement, player kinematics, and/or biometric signals, among other factors.

Eye tracking allows for any field of view restriction and/or field of view changes to be less noticable and/or imperceptible to the operator. Whether or not the limited field of view or the changing field of view is perceptible to the operator, using eye tracking to move the restrictor can help the operator see parts of the scene that would otherwise be occluded if there was no eye tracking, while maintaining the benefits of a limited field of view. It is contemplated that the eye tracker 124 can be any suitable tracking equipment that can determine where an operator is looking in the virtual environment.

In one embodiment, eye tracking allows the field of view restrictor 112, or the transparent portion of the field of view restrictor 112, to be moved or modified such that it is centered about the operator's line of sight. For example, if the dynamic aperture 114 moves with the gaze ray (the ray in the direction in which the eye of an operator of the system is looking), such that if the operator's eye looks upward, then the field of view restrictor moves upward. Changing the way in which the field of view is restricted based on eye tracking can provide for field of view restriction to be more subtle or imperceptible to the operator than if eye tracking were not used. For example, eye tracking can be used to move the portion of the field of view that is restricted to follow the respective eye, providing for the field of view to remain centered about the operator's line of sight. In this case, eye tracking can be used not to change how much of the FOV is restricted, but where it is restricted, reducing the operator's awareness of the restriction by keeping the restricted portions of the field of view away from the operator's line of sight. This can be advantageous in head-worn displays in which the operator is free to move their eyes, as well as in displays that are not head-worn. In displays that are not head-worn, both eye movement and head movement can determine the portion of the physical display that the operator sees; if eye tracking was not used to move the field-of-view restrictors in conjunction with the operator's line of sight, it could be easier for an operator to notice if field of view restriction were employed.

Additionally, it is contemplated that for displays of extremely large field of view, the field of view restrictor 112 can be a texture mapped onto a nonplanar surface.

FIGS. 2A-2C each schematically illustrate embodiments of the dynamic aperture 114 disclosed above. As shown in FIG. 2A, the dynamic aperture 114 can be a hard edge aperture. As shown in FIG. 2B, the dynamic aperture 114 can be a variable transparency aperture. As shown in FIG. 2C, the dynamic aperture 114 can be an arbitrary aperture having a deformable shape and transparency.

Referring again to FIG. 1A, the virtual reality system 100 also includes controller 108. The controller 108 facilitates the control and automation of the virtual reality system 100. The controller 108 can be coupled to or in communication with each of the virtual reality device 102, the display 104, the at least one eye tracker 124, the field of view restricting system 106, the field of view restrictor112, and/or the dynamic aperture 114, for example by a wired or wireless connection. Also, the controller 108 can adjust the field of view restrictor 112 in real time to thereby cause the restricted field of view to be rendered on the display 104 and/or seen by the operator. Examples of a controller 108 can include, but are not limited to, a desktop, laptop, backpack, or pocket computer (which can drive a separate headset), a self-contained headset (e.g., Microsoft HoloLens), or a smartphone (which can be attached to a headset, such as a Samsung Gear VR).

The dynamic aperture 114 can scale as a function of optical flow, player movement, player kinematics, and/or biometric signals, among other factors, as received by the controller 108. The controller 108 is also adapted to control movement of the dynamic aperture 114 such that a center of the dynamic aperture 114 follows the central line of sight of the operator. As such, adjustments can be made on the fly by the controller 108 to help combat virtual reality sickness for an operator using a VR display.

In certain embodiments, the controller 108 is adapted to determine where to restrict the field of view. The controller 108 dynamically changes the field of view in response to virtual motion-decreasing the field of view when the operator moves virtually and gradually restoring the field of view when the operator stops. As discussed, the field of view can be restricted using soft-edged cutouts, which can allow for dynamic changes to occur subtly.

The controller 108 can include a central processing unit (CPU) 132, memory 134, and support circuits (or I/O) 136. The CPU 132 can be one of any form of computer processors that are used for controlling various processes and hardware (e.g., electronic systems, displays, and other hardware) and monitor the processes (e.g., time and component status). The memory 134 is connected to the CPU 132, and can be one or more of a readily available memory, such as random access memory (RAM), read only memory (ROM), floppy disk, hard disk, or any other form of digital storage, local or remote. Software instructions and data can be coded and stored within the memory for instructing the CPU 132. The support circuits 136 can also be connected to the CPU 132 for supporting the processor in a conventional manner. The support circuits 136 can include conventional cache, power supplies, clock circuits, input/output circuitry, subsystems, and the like. A program (or computer instructions) readable by the controller 108 implements any methods described herein and/or determines which tasks are performable. The program can be software readable by the controller 108 and can include code to monitor and control, for example, the position and/or of the aperture. In certain embodiments, the controller 108 can be a PC microcontroller. The controller 108 can also automate the sequence of the process performed by the virtual reality system 100. The controller 108 can also include a graphics processing unit (GPU).

Furthermore, in some embodiments, an input tool 130 is operatively connected to the controller 108. The input tool 130 can be used to move the operator and/or the operator's avatar in or through the virtual environment. The input tool can be, by way of example only, a handheld controller, joystick, pedal, keyboard, wand, or any other suitable input device.

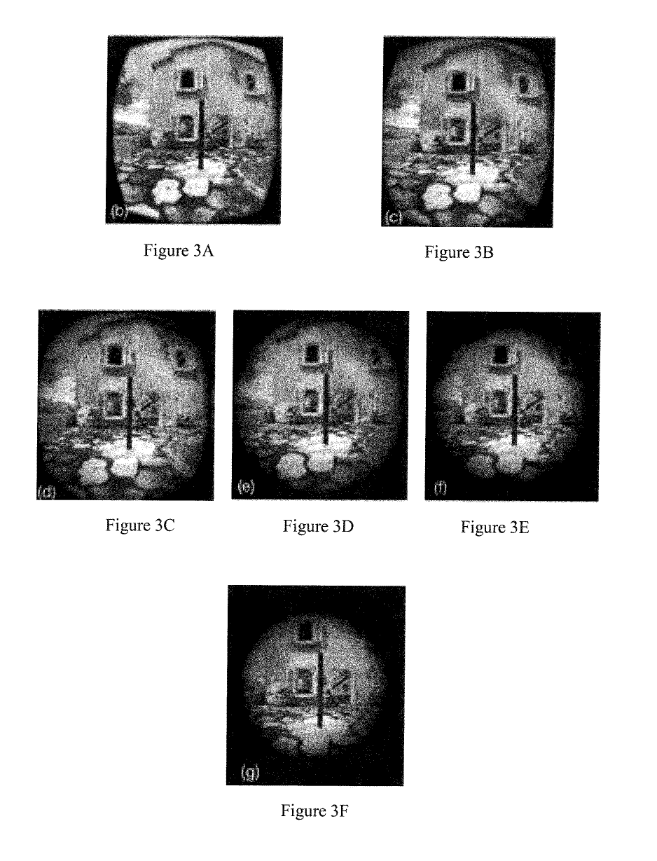

FIG. 4A schematically illustrates a view as seen from a third person view, without the use of a field of view restrictor or eye tracking. FIG. 4B schematically illustrates the view of FIG. 4A as seen by the operator on a display.

FIG. 4C schematically illustrates a view as seen from a third person view via the use of an unscaled field of view restrictor. FIG. 4D schematically illustrates the view of FIG. 4C as seen by the operator on a display.

FIG. 4E schematically illustrates a view as seen from a third person view via the use of a scaled hard-edge field of view restrictor. FIG. 4F schematically illustrates the view of FIG. 4E as seen by the operator on a display.

FIG. 4G schematically illustrates the view of FIG. 4E as seen by the operator on a display when a scaled soft edged field of view restrictor is utilized.

As shown in FIG. 4H, the same effect on the display as in FIG. 4F can be achieved by moving the unscaled field of view restrictor of FIG. 4C in the direction of an optical axis of the operator's eye.

### Example 1

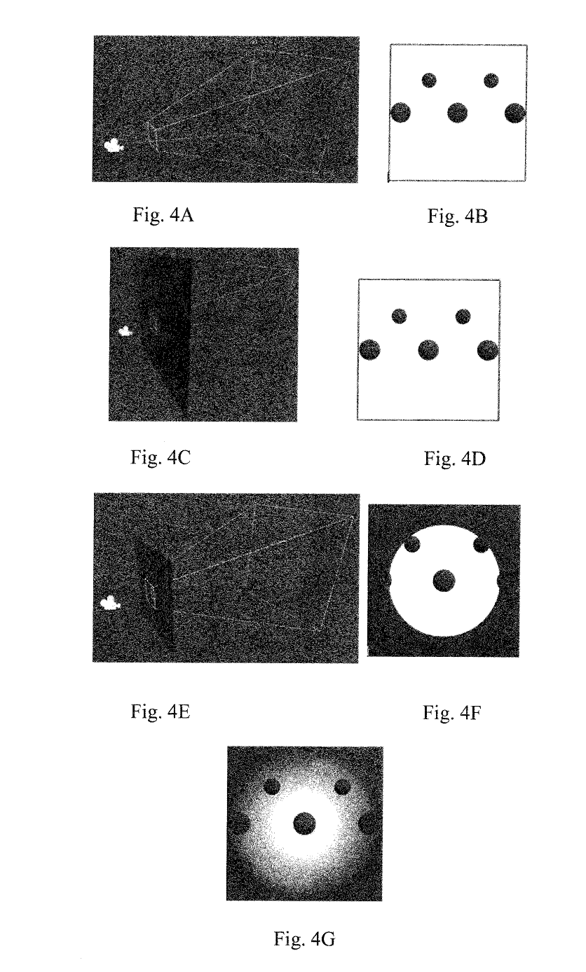

By way of example only, as shown in FIGS. 5A and 5B, an operator is looking at the top left of their display. The hard edged scaled field of view restrictor shown in FIG. 5A is translated in its plane maintaining that its center intersects with the gaze ray G, which corresponds to where the operator is looking. The optical axis OA and the frustrum are unchanged as the operator only moves their eyes and not their head. The field of view restrictor is centered when the gaze ray G and optical axis OA are collinear. FIG. 5C schematically illustrates the display as viewed by the operator when a soft edged cutout is utilized in conjunction with FIG. 5A.

### Example 2

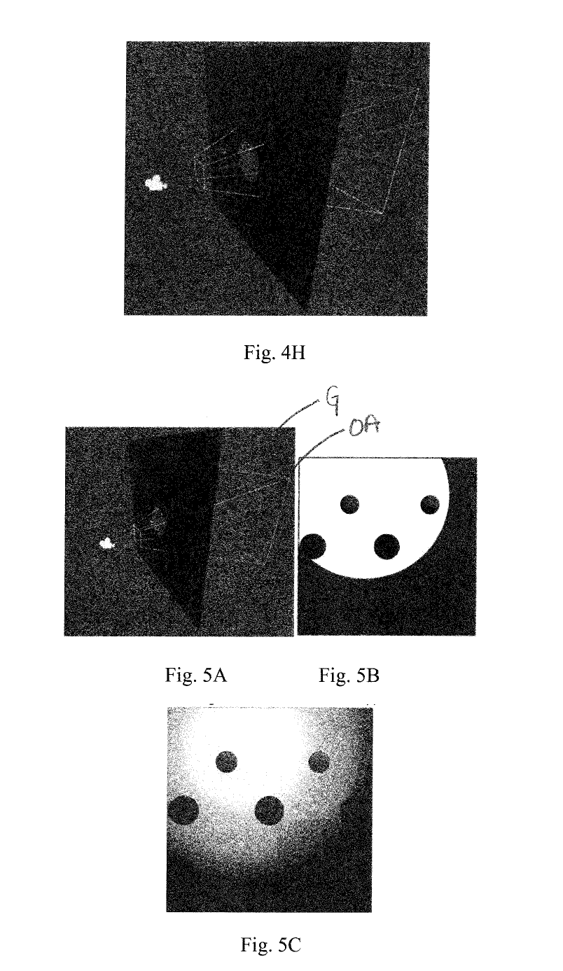

By way of example only, as shown in FIG. 6, the field of view restrictor shape, texture, design, scaling, and/or deformation can be independent from field of view restrictor to field of view restrictor. As shown, the virtual camera 600 shows a view of the virtual environment. The virtual camera 600 generally moves as a child of the head (moves with the head), but not the eyes. Camera frustrum 602 details the volume of what the virtual camera 600 sees in the virtual environment. Field of view restrictor 604 is shown parallel to the base of the camera frustrum 606. While FIG. 6 illustrates that the center of the aperture is placed on the center of its cross section with the viewing frustrum 602, this is not required. The field of view restrictor or the aperture can scale up or down to occlude more or less of the scene from the virtual camera 600. However, the field of view restrictor 604 can extend across the entire cross section of the frustrum 602, to prevent the operator from being able to view the scene around the perimeter of the field of view restrictor 604. The field of view restrictor 604 can move vertically and horizontally, parallel to the base of the frustrum 602. In this embodiment, the field of view restrictor 604 does not rotate around any axis. Rather, moving in the direction of the optical axis can scale the field of view restrictor 604. Gaze ray 608 represents where the operator is looking. The field of view restrictor 604 translates such that a center of the field of view restrictor 604 moves in response to where the gaze ray 608 intersects the plane of the field of view restrictor 604. Gaze ray 608 does not move the virtual camera 600.

### Example 3

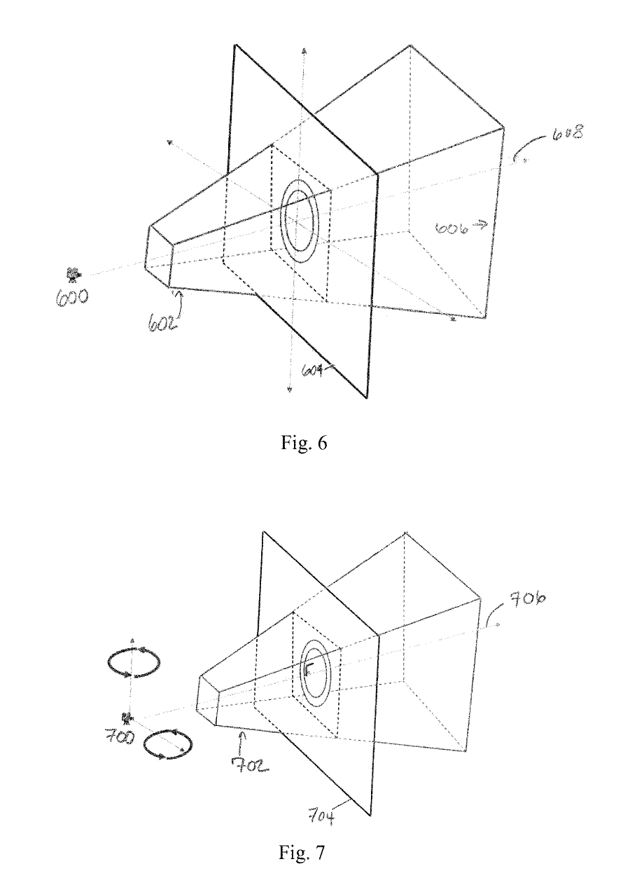

By way of example only, as shown in FIG. 7, the field of view restrictor shape, texture, design, scaling, and/or deformation can be independent from field of view restrictor to field of view restrictor. As shown, the virtual camera 700 shows a view of the virtual environment. The virtual camera 700 generally moves as a child of the head in that it moves relative to head, but not the eyes of the operator. The view frustum 702 sets the boundaries of what the virtual camera 700 sees in the virtual environment. The center of the aperture is placed on the center of its cross section with the viewing frustum 702, however this is not required. In some embodiments, the field of view restrictor 704 (or the aperture) can scale down to occlude more or less of the scene from the virtual camera 700. However, the field of view restrictor 704 can extend across the entire cross section of the frustum 702, to prevent the operator from being able to view the scene around the perimeter of the field of view restrictor 704. Each field of view restrictor can rotate (yaw and/or pitch) around the location of the virtual camera 700. Gaze ray 706 is perpendicular to the restrictor plane. The gaze ray 706 represents where the operator is looking. The field of view restrictor 704 moves such that a center of the field of view restrictor 704 moves in response to where the gaze ray 706 intersects the plane of the field of view restrictor 706. The gaze ray 706 does not move the virtual camera 700.

The present disclosure is not limited to specific virtual reality, augmented reality, or mixed reality equipment, and as such any type of virtual reality, augmented reality, and/or mixed reality equipment is suitable for use with the present disclosure. Testing of example embodiments of the present disclosure was performed using an Oculus Rift DK2 HWD with integrated 6DOF position and orientation tracking, driven by Oculus SDK 0.4.4 on an AMD Phenom II X4 965 Black Edition Quad Core Processor (3.4 GHz), 8 GB RAM, with Nvidia GeForce GTX 680 running Windows 8.1. 6DOF head tracking allowed for a seated operator to translate and rotate their head within the tracking volume of the DK2. In addition to 6DOF-head-tracked control of the view, a Logitech Gamepad F310 controller was used to translate along the ground and rotate the up axis. The application was developed using the Oculus Rift Tuscany demo using Unity 4, and ran at an average of 75 frames per second, with a measured latency of 15-30 ms.

Testing results indicate that the presently disclosed field of view restrictor is imperceptible to a majority of operators. Furthermore, the presently disclosed field of view restrictor significantly decreases the level of VR sickness and/or cybersickness experienced by operators in comparison to a control group which utilized no field of view restrictors.

Benefits of the present disclosure include the dynamic, yet subtle, change in field of view of the virtual environment in order to decrease, ease, or prevent VR sickness and/or cybersickness while said change is imperceptible to the operator. Also, the field of view restrictors can be used as an adaptation tool in order to help operators and new users get their “VR legs.” Additional benefits include eye tracking to continuously move the portion of the field of view that is restricted, thus increasing the imperceptibility of the field of view change and increasing the degree to which the field of view can be restricted. As such, the field of view can remain centered about the operator's line of sight, which minimizes the operator's awareness of any restriction by keeping the restricted portions of the field of view away from the operator's line of sight. Furthermore, the present disclosure can be utilized in both head-worn displays/virtual environments and in displays/virtual environments that are not head worn.

While the foregoing is directed to embodiments described herein, other and further embodiments can be devised without departing from the basic scope thereof, and the scope thereof is determined by the claims that follow.

What is claimed is:

1. A virtual reality system for rendering a restricted field of view on a display, comprising:
a virtual reality headset;
at least one display operatively connected to the virtual reality headset;
at least one eye tracker configured to track a gaze of an eye of an operator, wherein the at least one eye tracker is operatively connected to the virtual reality headset;
an eye-tracked field of view restricting system comprising:
at least one field of view restrictor having a static or dynamic aperture of variable transparency, wherein the at least one field of view restrictor is configured to move as a function of the gaze of the eye of the operator; and
a controller operatively connected to the virtual reality headset, the display, the at least one eye tracker, and the eye tracked field of view restricting system, and adapted to adjust the at least one field of view restrictor in real time in response to the at least one eye tracker.

2. The virtual reality system of claim 1, wherein the aperture has an inner radius and an outer radius defining an opening, and wherein the opening is adapted to increase in opacity from transparent within the inner radius to opaque beyond the outer radius.

3. The virtual reality system of claim 1, wherein the at least one field of view restrictor is adapted to dynamically change in scale, transparency, color, or shape.

4. The virtual reality system of claim 3, wherein the movement of the at least one field of view restrictor is imperceptible to the operator.

5. The virtual reality system of claim 3, wherein the movement of the at least one field of view restrictor is noticeable to the operator.

6. The virtual reality system of claim 1, further comprising an input tool operatively connected to the controller.

7. The virtual reality system of claim 1, wherein the aperture comprises a texture scalable as a function of optical flow, player motion, or a biometric signal, as received by the controller.

8. The virtual reality system of claim 1, wherein a size of the aperture is adjustable in response to physical motion of the virtual headset.

9. The virtual reality system of claim 1, wherein the at least one field of view restrictor moves in response to at least one eye of the operator.

10. The virtual reality system of claim 1, wherein the controller further causes the restricted field of view to be rendered on the display.

11. The virtual reality system of claim 1, wherein the aperture is a hard edge aperture or an arbitrary aperture having a deformable shape and transparency.

12. A virtual reality system for rendering a restricted field of view on a display, comprising:
a virtual reality headset;
at least one display operatively connected to the virtual reality headset;
a field of view restricting system comprising:
at least one field of view restrictor having a static or dynamic aperture disposed in proximity to a center of the field of view restrictor, the aperture having an inner radius and an outer radius defining an opening, wherein the opening is adapted to increase in opacity from transparent within the inner radius to opaque beyond the outer radius; and
a controller operatively connected to the virtual reality headset, the display, and the field of view restricting system, and adapted to adjust the at least one field of view restrictor in real time.

13. The virtual reality system of claim 12, wherein the at least one field of view restrictor is adapted to dynamically change in scale, transparency, color, or shape.

14. The virtual reality system of claim 12, wherein the movement of the at least one field of view restrictor is imperceptible to the operator.

15. The virtual reality system of claim 12, wherein the aperture comprises a texture scalable as a function of optical flow, player motion, player velocity, or a biometric signal, as received by the controller.

16. The virtual reality system of claim 12, wherein a size of the aperture is adjustable in response to physical motion of the virtual headset.

17. The virtual reality system of claim 12, wherein the controller further causes the restricted field of view to be rendered on the display.

18. The virtual reality system of claim 12, wherein the dynamic aperture is a hard edge aperture, a variable transparency aperture, or an arbitrary aperture having a deformable shape and transparency.

19. A virtual reality system for reducing virtual reality sickness, comprising:
a device;
at least one display operatively connected to the device;
an eye tracker configured to track a gaze of an operator, wherein the eye tracker is coupled to the virtual reality device;
an eye-tracked field of view restricting system comprising:
at least one field of view restrictor having a dynamic aperture, wherein the at least one field of view restrictor is configured to move as a function of the gaze of the operator;
a controller operatively connected to the device, the display, the at least one eye tracker, and the eye tracked field of view restricting system, and adapted to adjust the at least one field of view restrictor in real time in response to the eye tracker; and
an input tool operatively connected to the controller.

20. The virtual reality system of claim 19, wherein the dynamic aperture is a hard edge aperture, a variable transparency aperture, or an arbitrary aperture having a deformable shape and transparency, and wherein a size of the aperture is adjustable in response to physical motion within the virtual reality device.
